(19) United States
(12) Patent Application Publication
(10) Pub. No.: US 2013/0295534 A1
(43) Pub. Date: Nov. 7, 2013

(54) METHOD AND SYSTEM OF COMPUTERIZED VIDEO ASSISTED LANGUAGE INSTRUCTION

(71) Applicant: Meishar Meiri, Tel Aviv (IL)

(72) Inventor: Meishar Meiri, Tel Aviv (IL)

(21) Appl. No.: 13/465,071

(22) Filed: May 7, 2012

(51) Int. Cl. G09B 19/00

(52) U.S. Cl. 434/157

(57) ABSTRACT

A computerized method of language instruction which relies on language annotated video, such as popular third party videos which may be downloaded or streamed from third party servers or other sources. Here the language instruction service will generate instruction scripts containing native language text and translated text of the video, along with various computer instructions. This instruction script may then be read by script interpreter software which may run within a web browser. The system can interpret user GUI commands, such as mouse hovering commands to control playback of the third party video and annotate this playback with various language instruction tools and games.

### BACKGROUND OF THE INVENTION

1. Field of the Invention

This invention is in the field of computerized foreign language instruction and reinforcement technology.

2. Description of the Related Art

Despite the intense interest in computerized methods of foreign language instruction and reinforcement, learning a foreign language is often a difficult and painful task.

There are a number of popular computerized language instruction methods that have had some commercial success. For example, RosettaStone, Inc. of Arlington Va. produces and distributes a popular series of computerized language instructional materials. These computerized instructional materials operate, for example, by showing images of various common activities, such as eating, along with text and sound describing the various activities in a foreign language of interest. The system then requests that the language student click on the appropriate image that matches the appropriate text and sound.

Other work in this field includes Masoka, US patent application 2011/0059422, who taught a Physiological and Cognitive Feedback Device, System, and Method for Evaluating a Response of a User in an Interactive Language Learning Advertisement. Erskine et. al., in US patent application 2008/028490 taught a system and method for text data for Streaming Video. Chen et. al., in U.S. Pat. No. 7,991,801 taught a real-time dynamic and synchronized captioning system. Goto et. al., in U.S. Pat. No. 8,005,666 taught an automatic system for temporal alignment of music audio signal with lyrics. Nguyen, in US patent application 2011/0020774 taught a computerized system and method for facilitating foreign language instruction.

Despite these advances, language instruction today is still largely practiced in classrooms, and by interpersonal interactions with instructor and/or with other language students. Indeed Berlitz Languages Inc., a Benesse Corporation, still has a very successful language instruction business that remains based on its 130 year old human teaching method that largely relies on a direct person-to-person conversational approach (oral conversational approach) to foreign language teaching.

Unfortunately such oral conversational approaches, although effective, tend to be both expensive and inconvenient. Thus further advances in computerized foreign language instruction and reinforcement would be useful.

### BRIEF SUMMARY OF THE INVENTION

The invention is based, in part, on the insight that we learn language as children not by watching static images, but by observing motion around us and correlating this motion first with various sounds, and later with the written form of the language.

The invention is also based, in part, on the insight that although as small children, we are easily amused by almost any moving object, as older children and adults, we tend to be much more discerning. In order to hold our attention, these moving images and sounds must be compelling. Here most language instructional material falls far short of this “compelling” standard. Rather, language instructional materials are almost always custom-made for language instructional purposes. Usually the language instructional materials are created by individuals or institutions with little experience in producing compelling entertainment. As a result, language instructional material is often dull and boring to watch.

The invention is also based in part, on the insight that since our minds generally remember best when viewing compelling material, such as compelling movies, a computerized language instruction and reinforcement system based on popular and compelling movies and videos would have many advantages. Here, however, such popular and compelling movies and videos are almost never designed for language instruction. In order to utilize popular videos (here the term video will encompass both videos and movies) for language instruction applications, these popular videos must somehow be repurposed for language instruction applications.

Unfortunately, under modern copyright law, the burden of obtaining copyright permissions for repurposing such popular movies and videos can be almost overwhelming. Thus in a preferred embodiment, the invention should be capable of repurposing such popular movies and videos in a manner that is generally compatible with at least the fair use provisions of prevailing international copyright law, and which otherwise minimizes the burden of obtaining such permissions.

The invention is thus based, in part, on the concept of developing various computerized language instruction and language reinforcement methods which are keyed or synchronized to popular videos, but which may be distributed independently of such videos. Thus in at least some embodiments, the language material user (i.e. student) may obtain the language instructional materials from one source, obtain the rights to various popular videos from another source, and then the two types of materials or media into a single computer operated system that effectively utilizes the compelling qualities of popular videos for language instructional purposes.

Thus in one embodiment, the invention may be a computerized method of language instruction which relies on language annotated video, such as popular third party videos which may be downloaded or streamed from third party servers or other sources. Here the language instruction service will generate instruction scripts containing native language text and translated text of the video, along with various computer instructions. This instruction script may then be read by script interpreter software which may run within a web browser. The system can interpret user GUI commands, such as mouse hovering commands to control playback of the third party video and annotate this playback with various language instruction tools and games.

### BRIEF DESCRIPTION OF THE DRAWINGS

FIG. 1A shows an overview of the user computerized device interacting with a first language instruction server and a third party video media server.

FIG. 1B shows FIG. 1A more from the software perspective, showing in more detail how the invention's script interpreter software, running on the user computerized device, may manage the invention's various software implemented methods

FIG. 2 shows an example of an internet browser based embodiment of the invention, here showing an initial introduction page.

FIG. 3 shows the system instructing users that simply using a mouse or other pointing device to hover over a control area can control playback of the third party video.

FIG. 4 shows the system instructing users that simply using a mouse or other pointing device to hover (stand) over a particular word not only pauses the video, but also brings up a translation of that word.

FIG. 5 shows an example of a system defining a word, here again controlled by simply having a mouse or other pointing device hover over the word of interest.

FIG. 6 shows the system briefly showing the English version of the entire displayed French phrase.

FIG. 7 shows that by selecting another control region, the user can elect to turn on or turn off simultaneous versions of the French and English versions of the phrase.

FIG. 8 shows how the system may keep track of the user's various word inquiries and mistakes, and use this information to provide various statistical estimates of language learning progress and effective vocabulary size.

FIG. 9 shows a first example of a language game, in which a user hear a sentence or phrase in the first language to be learned (here French), and attempts to select the correct corresponding sentence or phrase in the first language that the user is already familiar with (here English).

FIG. 10 shows a second example of a language game, in which the user sees various parts of a sentence or phrase displayed in scrambled order, and is instructed to put the parts into the correct order.

FIG. 11 shows a third example of a language game, in which the user is invited to repeat a phrase into a microphone, and determine, by audio playback or graphical indicators, how closely the user's spoken first language words match the original first language words.

FIG. 12 shows an example of how the system can also highlight different words in the first language to be learned, and use corresponding highlighting to more clearly show the correspondence between words in the first language to be learned and the second language that the user is already familiar with.

FIG. 13 shows an example of a user selecting a word in the second language that the user is already familiar with that corresponds to a highlighted word in the first language to be learned.

### DETAILED DESCRIPTION OF THE INVENTION

In one embodiment, the invention may be a computerized system or method of language instruction or practice. Generally the invention will be based on obtaining video or audio media (which may be third party video or audio media), here with a corresponding audio sound track that contains spoken words in at least a first language to be learned. The video media will generally comprise movies and other video such as recorded television programs, independent user produced videos, and the like. The invention's methods may also work with pure audio media as well, and since it is cumbersome to repeatedly write “movies or video or audio media”, unless otherwise specified, use of the term “video media” should be construed as usually encompassing audio media as well.

The invention also is based on obtaining the text, in both the first language to be learned, and also a second language that the user will be familiar with, of at least some of the spoken words on this video media. This text will generally be synchronized with the video media. This synchronization can be done by elapsed playback time, frame number, embedded visual or audio watermarks, or other indexing method. The text will often be produced by either human transcribers or translators, or by automated speech recognition methods.

The invention is also based on obtaining or producing various computer instruction scripts, which will generally be written in a computer language and configured to be executed by a processor in the user's computerized device, often by way of a script interpreter program such as script interpreter code running within a web browser, script interpreter software running within another type of applications software (e.g. within an “App”) and the like.

Here, for simplicity sake, the software script interpreter program will be termed a “script interpreter”. Although this script interpreter will generally take instructions from the various computer instruction scripts, as well as user input, and in turn control various computerized media players (e.g. windows media player) to run and stop the video at various sections.

In some embodiments, this “script interpreter” functionality can be encoded onto standard web pages using various techniques including HTML5 techniques, Java and/or JavaScript techniques, and the like. In other embodiments the script interpreter may be provided as a downloadable software or “app” that can, for example, be provided by a language instruction website, a software merchant, “App store” and the like, and then be downloaded and run on the user's computerized device

The instruction scripts will perform various functions. One function is to synchronize the text of these spoken words with their respective locations in the audio or video media (e.g. if the spoken word “cat” appears at 10 minutes and 23 seconds in the video media, then the computer instruction scripts will show this matching). The instruction scripts will also synchronize the text of the media's spoken words with the correct section or frames of the video or audio media, and also, often in combination with input from the user, control which synchronized text of the spoken words are displayed on the graphical user interface of a user's computerized device.

The instruction scripts may consist of various software commands intermixed with the text of the video spoken words in the first language to be learned and the second language that the user is familiar with, and thus the scripts and text can be in the same computer file. Alternatively the text may be in one file, and the instruction scripts may be in a separate file. Because generally the text and instruction scripts are used together, it is convenient to consider them as a single entity regardless of actual file structure.

Thus typically, when the user provides input to the graphical user display of the computerized device (e.g. by operating a mouse or other pointing device), these instructions will be sent by the processor to the script interpreter software. The script interpreter software in turn will be configured to accept the video media, the video or audio media synchronized text of the spoken words, and the instruction scripts. Then based on the user input, the script interpreter will play, on the computerized device graphical user interface (e.g. display screen and speaker), portions of the video media, as well as portions of the text that is synchronized with the video media.

The system and method will thus use the video media, the video media synchronized text of the spoken words, and the instruction scripts, in combination with input from the user, and the script interpreter, to convey language instruction to the user.

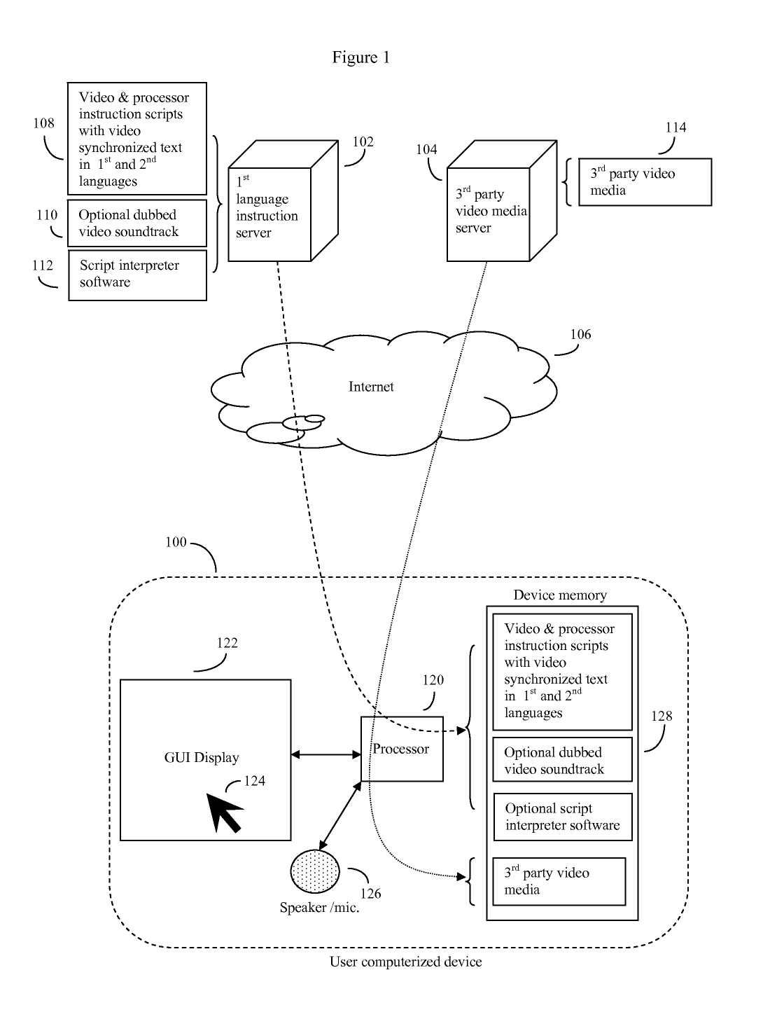

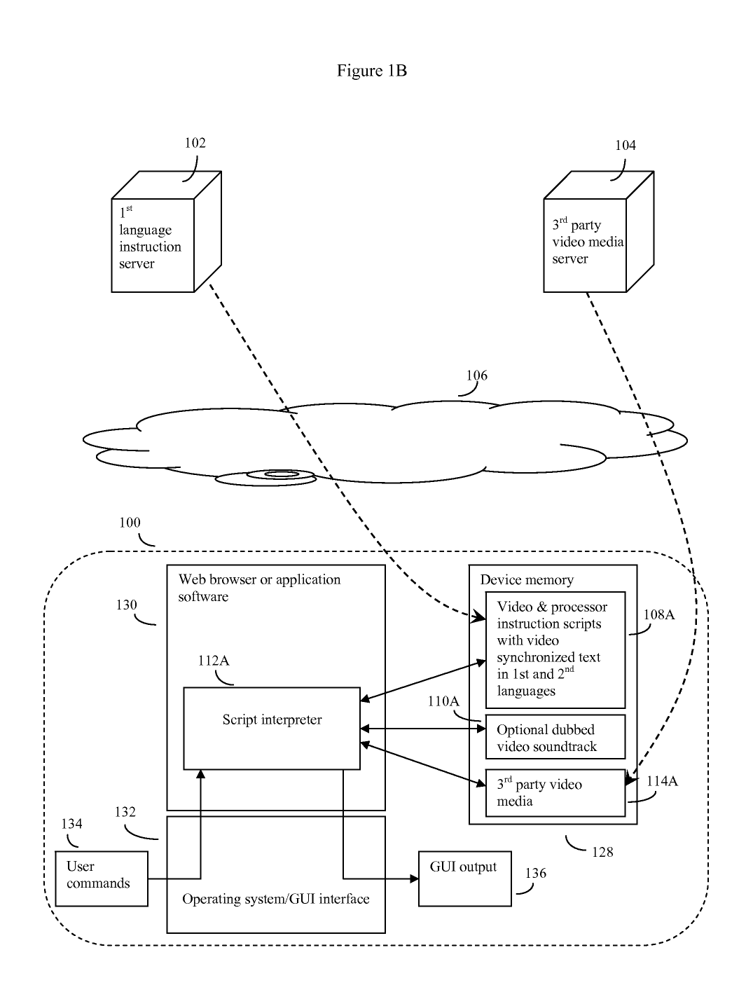

FIG. 1A shows an overview of the user computerized device (100) interacting with a first language instruction server (102) and a third party video media server (104), here over a computer network such as the Internet (106).

In this embodiment, typically the first language instruction server (102) will house data such as the instruction scripts and media synchronized text (108), an optional video media dubbed soundtrack (and dialog) (110), and often the script interpreter software (112) which can be downloaded to the user's computerized device (100). As previously discussed, when executed on the user's computerized device, the script interpreter software can then read and follow the instruction scripts and media synchronized text (108).

In this embodiment, often the audio or video media (114) used for language instruction purposes may be housed on a third party video media server (104). This third party video media server could be a server such as YouTube, Google Video, Bing Video, Apple iTunes, Netflix, Hulu, and the like. This video media may either be available for free download (or video streaming), or alternatively may be available for purchase and download or streaming.

For the purposes of this discussion, with regards to obtaining the video media over a network connection, the terms “download” and “streaming” will be used interchangeably and both methods may be used.

Note that although FIG. 1A shows obtaining the video media from a third party server, in alternative embodiments, the third party video media may be supplied in the form of physical computer storage media, such as a DVD or BlueRay™ disk, or other transferable video storage media instead. In other embodiments, the video media may be supplied by the same organization that is also supplying the instruction scripts.

Generally each different third party video (114) that selected for language instruction purposes will have its own unique instruction scripts and synchronized text (108). By contrast, the script interpreter software (112) can be more general purpose, and can be designed to operate with many different types of video media, many different types of instruction scripts and corresponding text for many different language types.

It is contemplated that to implement a comprehensive set of language instruction sessions, generally a plurality of third party videos (114) and a plurality of instruction scripts corresponding video synchronized text (108) will be prepared by the organization or individual wishing to provide language instruction services. Thus for example, a language instruction series based on ten different third party videos might deliver 10 different instruction scripts, but all 10 videos and instruction scripts may be run by the same script interpreter software (112).

A typical user computerized device (100) will be a desktop computer, laptop computer, tablet computer, Smartphone or other such device. The device will generally have at least one microprocessor (120), a display screen (122)—(typically a graphical user interface display screen system equipped with a pointing device such as a mouse or touch screen 124). The device will often also have an audio speaker or jack or wireless interface for an audio speaker (126). The device will often also have a microphone, jack for a microphone, or wireless interface for a microphone (not shown). The device will also usually have either a network interface, and/or an ability to accept data from moveable storage memory such as a DVD, BlueRay™ disk, solid state memory card, and the like (not shown). The device will also have internal storage memory (128), generally capable of holding at least as much data from the control scripts and text (108), script interpreter software (112), third party video media (114), and optional dubbed soundtrack (110) as needed as to control the processor (120) and perform the operations discussed herein. Often this device memory (128) will have a capacity of 1 Gigabyte or more. Additionally the device will generally contain operating system software (e.g. Linux, iOS, Windows, etc.) as needed to run the system (not shown).

Thus in some embodiments of the system and method, the first language instruction server (102) can be used to store the video or audio media synchronized text of the spoken words (in both the first language to be learned, and at least one second language that the user is expected to know) (108). This server (102) can also store the script interpreter software (112), which will later be downloaded to the user computerized device and run on the user computerized device.

As shown in FIG. 1A and also in the software oriented version of the process in FIG. 1B, at some time on or before the time that the user wishes to begin language instruction, the user's computerized device (100), will then, either under control of the scripts (108), or under user control obtain the appropriate video (or audio) media (114) from the third party server (104), often by downloading. The user's device will often also obtain the scripts (108) and script interpreter (112) as well, and indeed the process will often commence with downloading at least the script interpreter (112) and scripts (108) from the server (102).

As will be discussed in more detail later on, in some embodiments, the third party video media (114) may not be in the desired language to learn. Here, the third party video media (114) can be supplemented by an optional dubbed video soundtrack (110), which may be specially produced for language instructional purposes as needed.

Thus, as shown in FIG. 1A, in some embodiments, the video or audio media (114) may have spoken words in a second language (e.g. the language that the user already knows) or a third language (i.e. a language that the user neither knows or wants to learn). Here, this otherwise unusable media (114) may be dubbed with a synchronized audio file (110) comprising spoken words in the first language (the language that the user wants to learn).

Here, then file (110) will be a video synchronized audio file containing spoken words in the first language that the user wants to learn, and this can be stored in the first language instruction internet server (102). Thus when the user wants to learn a language, the user's computerized device (100) can be set to download the relevant instruction scripts and synchronized text (108) (here synchronized to the dubbed soundtrack 110), as well as the video media (114) from the third party server (114), and the language instruction can then commence using the dubbed video soundtrack (110).

In some embodiments, such as the examples to be discussed below, the script interpreter software that controls the graphical user interface can run under a web browser on the user's computerized device (100). Alternatively or additionally, this web browser can download at least some of the elements of the script interpreter software (112) from the first language instruction internet server (102).

FIG. 1B shows the same process, here focusing more on the software that is running on the computerized devices. Here the downloaded forms of the instruction scripts (108), optional dubbed video soundtrack (110), script interpreter (112) and third party video media (114) are now shown running on the user computerized device as their corresponding counterparts (108A), (110A), (112A), and (114A). Here, the script interpreter (112A) may, for example run within a web browser or other application software (130). These in turn will often run under an operating system with a GUI interface (e.g. Windows, Linux, iOS, and the like) (132), all in turn executed by one or more microprocessors (120). In some embodiments, the script interpreter will be bundled within application software (130) and both will be downloaded or otherwise put into computerized device (100) simultaneously. The various user commands (134) (i.e. mouse hovering, clicks, button presses, etc. from hardware (124))) will usually be intercepted by the operating system (132) and transmitted to the script interpreter (112A). Output from the script interpreter (112A) in turn will control what sections of the instruction scripts and text (108A) will be executed next, and what sections of the video (114A) and optional dubbed soundtrack (110A) will be executed next. The output from the script interpreter (112A), usually running within the web browser or application software (130), will usually be sent back to the operating system and GUI interface and from there to the GUI and sound output (136) software interface and then on to GUI and sound hardware (122), (126).

As previously discussed, although in FIGS. 1A and 1B, the system is obtaining the third party video from an internet server (104) that serves third party video, the video media may be obtained from other sources as well. Indeed, in some embodiments, the scripts and text (108), (108A), optional dubbed video soundtrack (110) (110A), and script interpreter software (112), (112A) need not be obtained from a language instruction server (102). In general, according to the invention, any method of obtaining this information and putting it on the user computerized device (100) is contemplated.

Alternative methods of acquiring these files can include internet downloads, or streaming from alternative sources. Additionally, the data transmission may be by moveable memory storage devices, such as DVD disks, BlueRay™ disks, solid state memory cards, and the like.

Thus to generalize, in some embodiments, the invention's methods can operate by further loading and storing on the computerized device (100), the previously discussed information including the video or audio media synchronized text of said spoken words in both the first language to be learned and at least one second language that the user already knows, along with the instruction scripts (108A) and the script interpreter software (112A).

Then, when the user desires to begin language instruction, the user can obtain the video media (114A) from a third a third party source (e.g. purchase, rent, download). The user can then load at least portions of this video media into the computerized device memory (128), and then proceed with the language instruction.

In some cases, there may be an otherwise excellent and compelling third party video (114) (114A) that is suitable for language instruction purposes, but it may have been originally filmed in a language other than a language that the user wishes to learn, and no previously available dubbed version may be available or provided with the video (114) (114A).

In this case, the organization that provides the language instruction services may find it convenient to commission their own audio dub of the video or audio media (114), (114A) but provide this audio dub soundtrack (110), (110A) separately from the third party video or audio media, and deliver this dubbed soundtrack file (110), (110A) along with the other language instruction files such as (108), (108A).

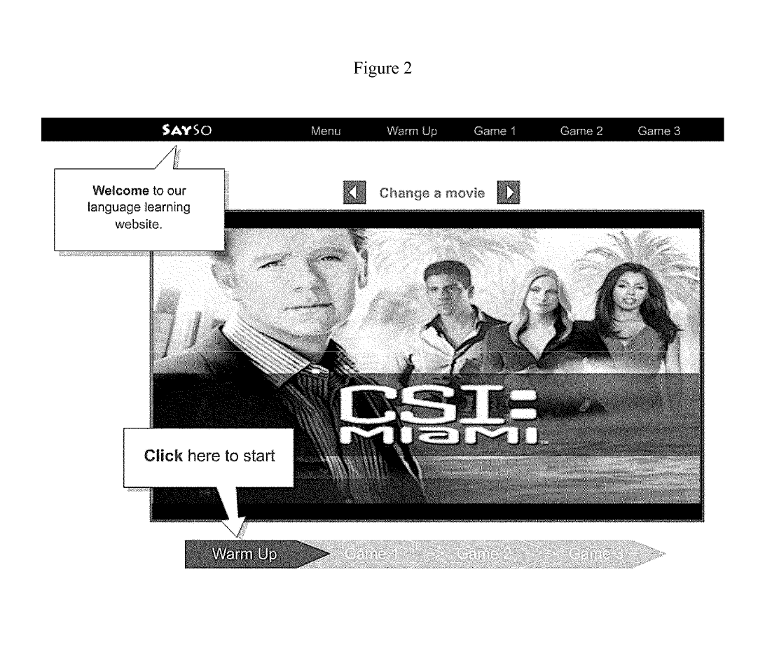

FIG. 2 shows an example of an internet browser based embodiment of the invention, here showing an initial introduction page. Here the first language instruction server (102) is called “SaySo”, and the third party video media server (104) may be a site such as YouTube.com, here playing a third party video which is the French version of an American television show: “CSI Miami”. In this example, the video media (114) is in a French first language that the user wishes to learn, and the second language that the user is already familiar with is English. This example is being played on a standard Internet Browser (here Microsoft Internet Explorer version 9) on a desktop computer running Microsoft Windows 7 operating system software.

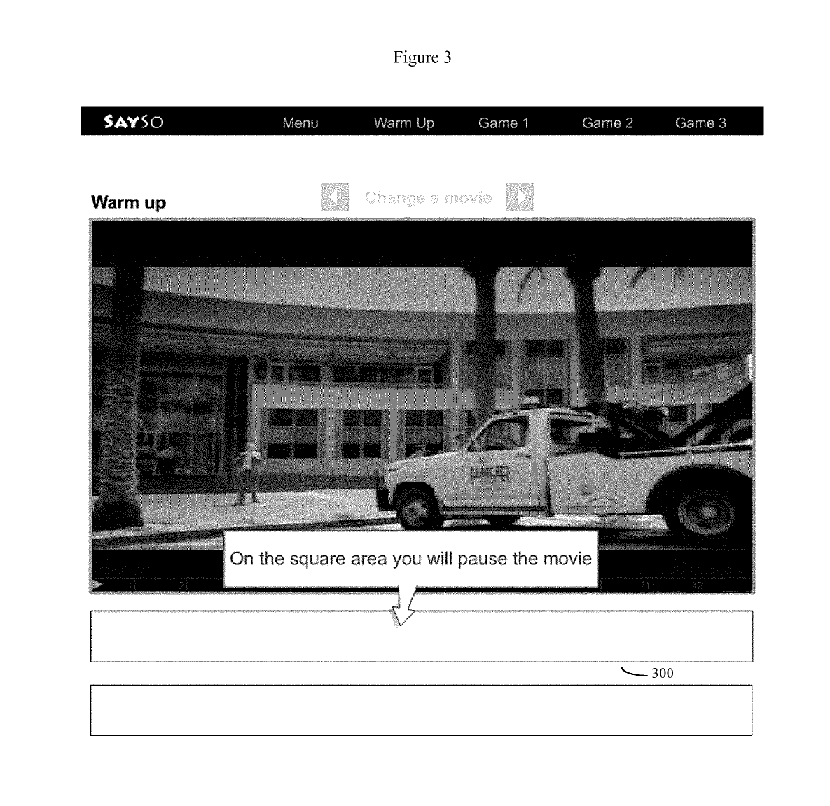

FIG. 3 shows the system instructing users that by simply using a mouse or other pointing device (124) to hover over a control area on the graphical user interface (122), the user can control the playback of the third party video (114) on the user device (100). Here the instruction scripts (108), (108A) instruct the script interpreter (112), (112A) to halt playback of the video (114) stop when the user places the mouse or pointing device (124), (134) over the control area (300) on the GUI display screen (122).

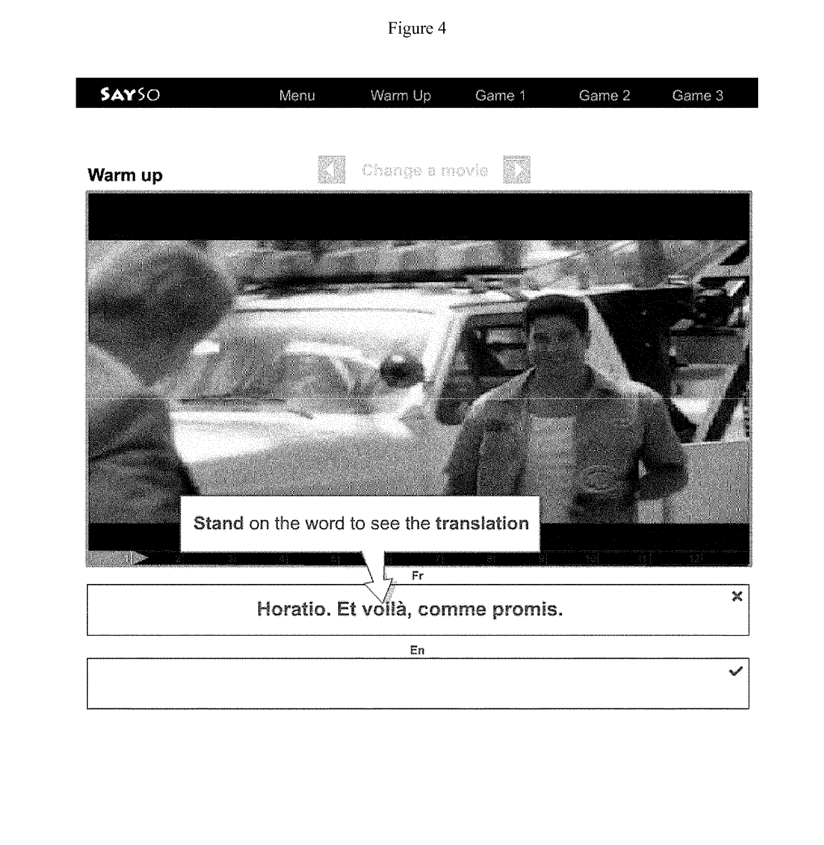

FIG. 4 shows the system instructing users that simply using a mouse (124) or other pointing device to hover (stand) over a particular text word, as displayed on the graphical user interface (122), not only pauses the device playback of the video, but also brings up a second language translation of that word.

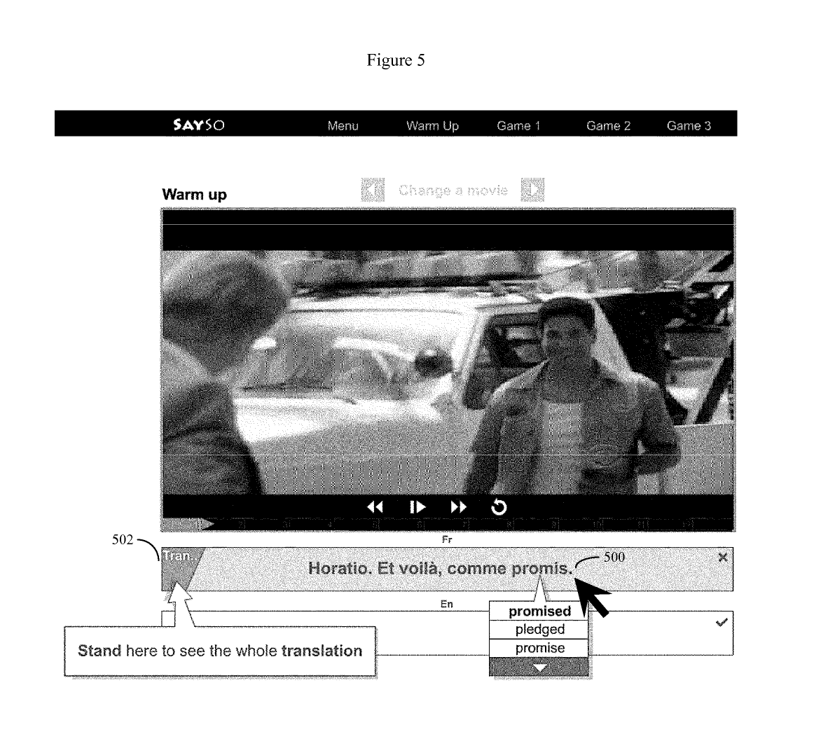

FIG. 5 shows an example of a system defining a first language (French) word in the second language (English), here again controlled by simply having a mouse (124) or other pointing device hover over the word of interest (500). The system is additionally instructing the user that one way to briefly see the entire French phrase is to move the mouse or other pointing device and direct it to hover (stand) over the “Tran . . . ” control region (502).

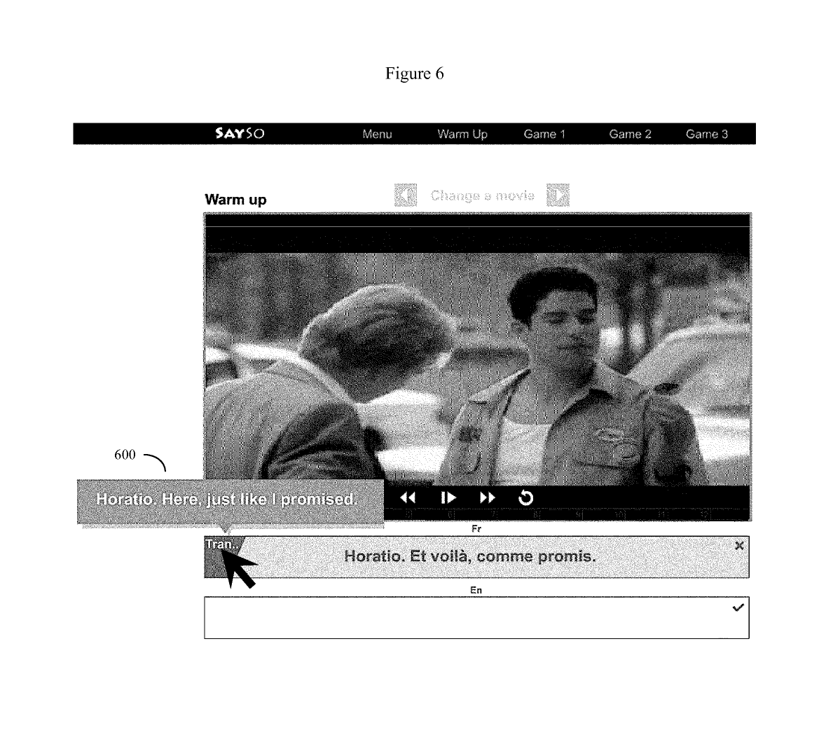

FIG. 6 shows the system briefly showing the second language (English) version (600) of the entire displayed first language (French) phrase. This brief showing of the English version (i.e. the language that the user already is familiar with) is useful for users who generally can understand much of the video's dialog in the language that they wish to learn (e.g. French), but who may need occasional help with difficult passages.

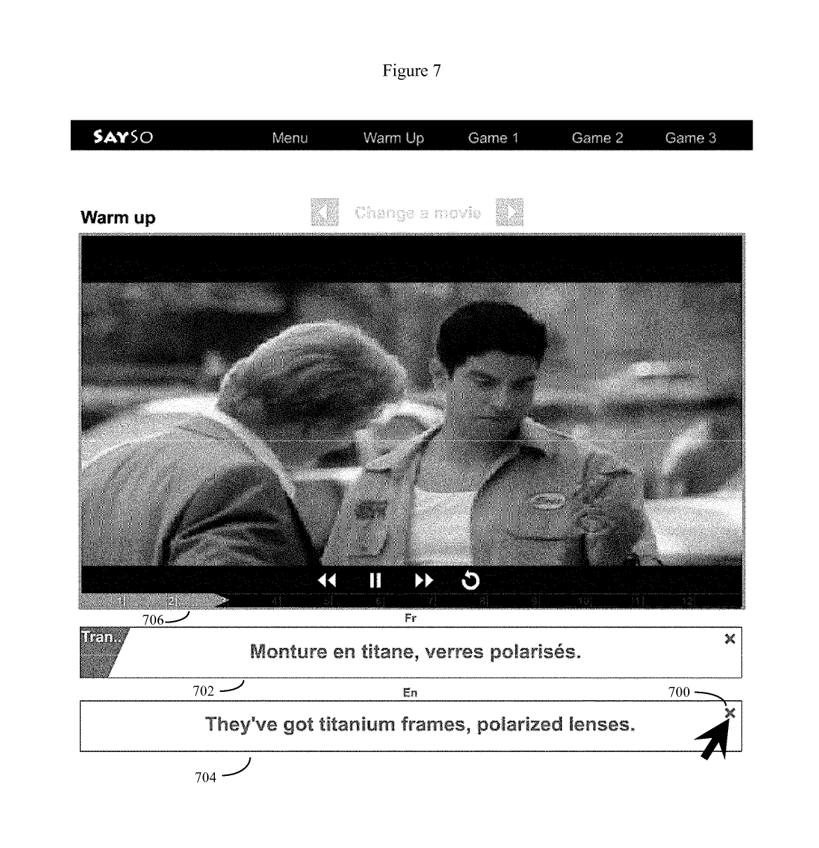

FIG. 7 shows that by selecting another control region (700), the user can elect to turn on or turn off simultaneous versions of the French (702) and English (704) versions of the phrase on a longer term basis (i.e. throughout this particular session). Note also the progress bar (706). This bar separates the video into various spoken phrases, which are often a text sentence or parts of a text sentence. By clicking various sections of this progress bar (706), the user may jump back and repeat a phrase of interest.

For this progress bar (706), generally the video and its corresponding synchronized text are broken down and indexed at the sentence or phrase level. The system can then display, on the graphical user interface, a selectable index, such as the progress bar (706), which allows the user to access or replay some of these indexed sentences or phrases, along with the corresponding playback from the corresponding sections of video media.

Thus as may be seen from FIGS. 2-7, the user may thus use the computerized device (100), along with the script interpreter and the instruction scripts, text, and video media to further play a portion of the video or audio media that generally corresponds to a spoken sentence, phrase, or part of a sentence. The system will usually both play the video, and also show on the screen (GUI) the corresponding (synchronized) text that goes along with that section of video. Often the text will be in the first language (same as either the video or at least a dubbed audio file of the video) that the student wishes to learn.

As previously discussed, the system (generally the script interpreter software) and instruction scripts may be configured to detect when the user's mouse or other pointing device (e.g. finger for a touch sensitive GUI display) hovers over a portion of this text. The system may then do various functions such as halting the video when the user's mouse or other pointing device is hovering over certain regions of the screen. This halt on hovering function may be implemented in various ways.

1: The system may, for example, detect when the user's mouse is said hovering over a specific word (in the first language to be learned). When this is detected, the system can then automatically display the corresponding text or definition of this specific word in the second language to be learned.

2: When the user hovers over a word in the first language, the translation of that word in the second language appears and the video clip may also halt (either immediately, or after the particular video segment reaches the end of the displayed text phrase, and before the next text phrase is displayed) until the user removes the mouse pointing from that word. This “halt until the mouse is removed” feature allows the user to make sure that he has understand his query properly. It also allows the user to stay synchronized with the video playback, and to not have to worry that the video will continue playing while the user tries to understand the previous word or sentence.

3: When the user hovers over the sentence or phrase area (rather than a specific word) in either language, the video can halt and the translated sentence can then be displayed until the user once again moves the mouse away from that area.

Put alternatively, in response to user input, the system can display, on the graphical user interface (122) portions of the text that is synchronized to the video in either the first language to be learned, and/or in the second language that the user is already familiar with. This generally will occur when this video (or audio) media (114) (114A) is played, under the software control of the script interpreter (112) (112A) and instruction scripts (108) (108A), on computerized device (100).

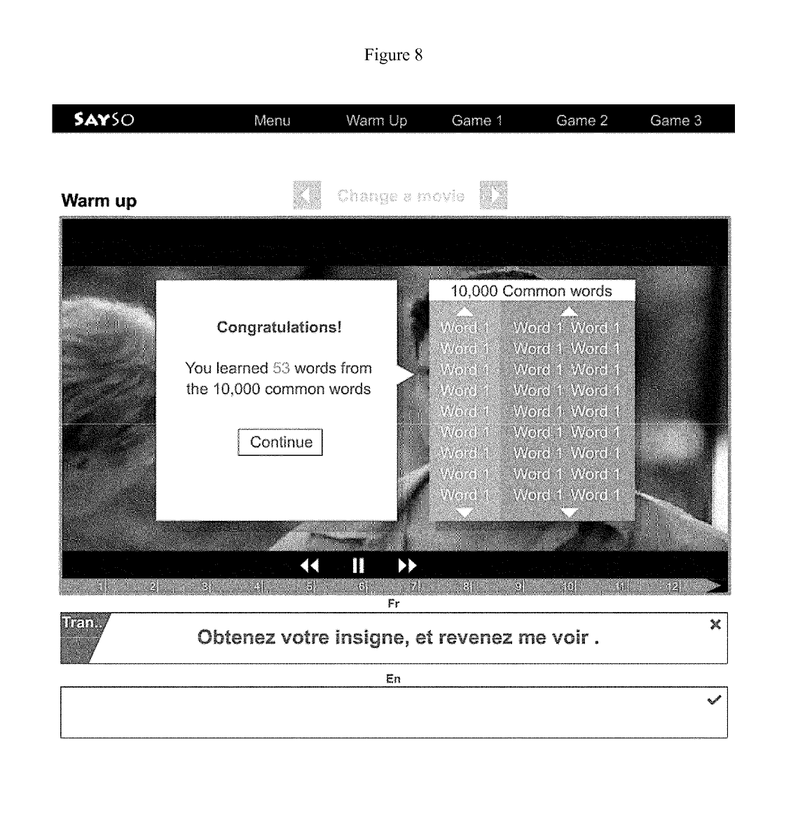

FIG. 8 shows how the system may keep track of the user's inquiries and mistakes, and use this to provide various statistical estimates of language learning progress and effective vocabulary size.

Here, for example, the computerized device, running the script interpreter software and instruction scripts, may keep a record of which specific words the user requested more information on by hovering, or which the user gets wrong in various games and tests (to be discussed). These specific words that the system detects the user is weak on can be compared to, for example, one or more reference lists of words in the first language to be learned. These reference lists of words can be, for example a list of the 1,000 most popular (most commonly used) words in the language to be learned, a list of the 2,000 most popular words. To generalize, the software can compare user competence versus a list of the “N” most popular words in the first language to be learned.

The system can then compare these specific “trouble” words with at least one list of the N most frequently used words in the first language, and use the overlap between this list of specific “trouble” words, and the list of the N most frequently used words to, for example, estimate the vocabulary of the user in the first language to be learned, or perform other statistical evaluations of language proficiency.

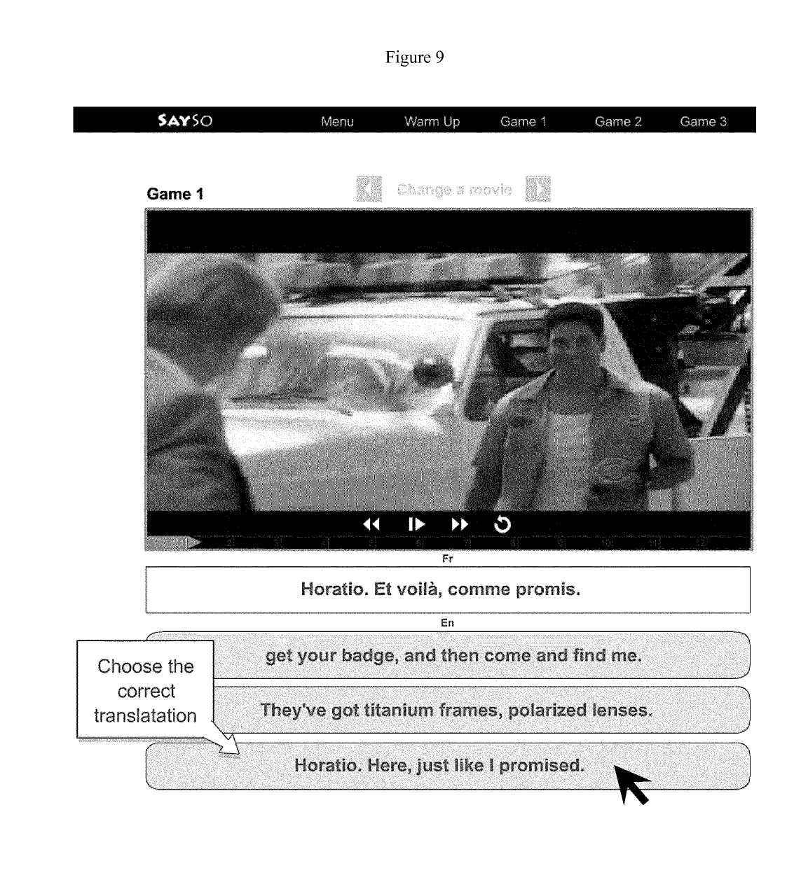

FIG. 9 shows a first example of a language teaching game, in which a user plays back a sentence or phrase in the first language to be learned (here French), and then attempts to select the correct corresponding sentence or phrase in the second language that the user is already familiar with (here English).

In this teaching game, the video (or audio) media synchronized text of spoken words in both the first language (to be learned) and at least a second language (that the user knows) can provide both correct and incorrect versions of the video synchronized text. Further, the instruction scripts which direct the script interpreter software to display both the correct and the incorrect versions of this synchronized text, can be set to further direct the user to select the correct version of this synchronized text. The script interpreter software (and the instruction scripts) can then detect this user selection, and inform the user as to the accuracy of this selection.

In some embodiments, the script interpreter software and instruction scripts can direct the system to highlight only a single word from a displayed text phrase (in the first language to be learned) at a time, and the user can then be given the option to choose the correct translation of that particular word in the second language that the user understands.

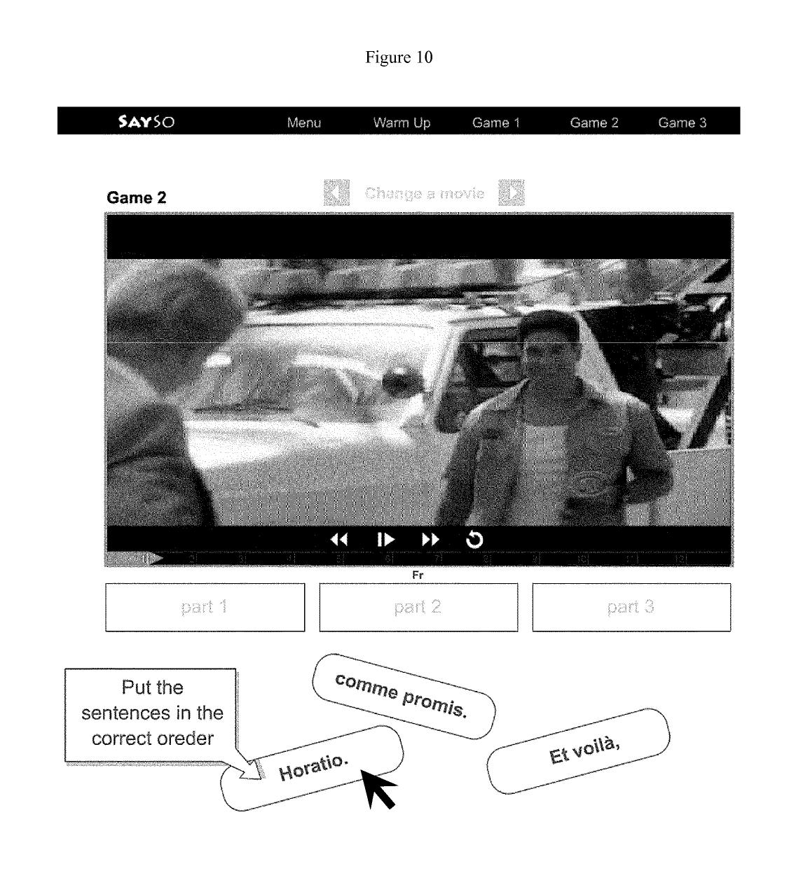

FIG. 10 shows a second example of a language teaching game, in which the user sees various parts of a first language sentence or phrase displayed in scrambled order, and is instructed to put the parts into the correct order.

In this type of instruction mode or game, the user will play at least some of the sections of the video (or audio) media using the script interpreter, instruction scripts (which will have actual or dubbed spoken words in at least the first language that the user wants to learn), and a media player controlled by the script interpreter. Then, generally on a video section basis, the instruction scripts will instruct the script interpreter to break down the corresponding first language text into various subunits, and display these various sub units in a jumbled or non-correct order.

If the user then selects these text subunits in an incorrect order, the instruction scripts can instruct the script interpreter to display an error message on the graphical user interface. By contrast, if the user selects the text subunits in a correct order, the instruction scripts can instruct the script interpreter to display a confirmation message on the graphical user interface (122).

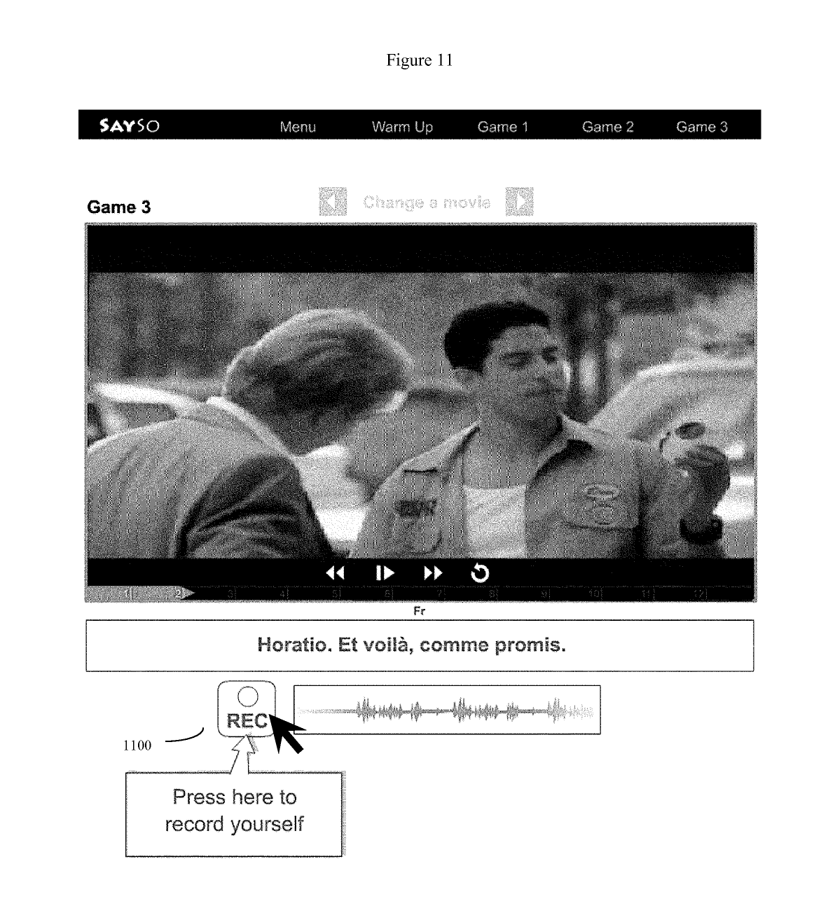

FIG. 11 shows a third example of a language teaching game, in which the user is invited to repeat a phrase into a microphone (e.g. 126), and determine, by audio playback or graphical indicators, how closely the user's spoken first language words match the original first language words.

In this example, the script interpreter software can provide a user interface (1100) on the graphical user interface (122) that allows the user to speak the same words as were just played on the video, and compare, by either audio playback and/or visual sound comparison graphics, the similarities and differences between the user's speaking and the same words from the video.

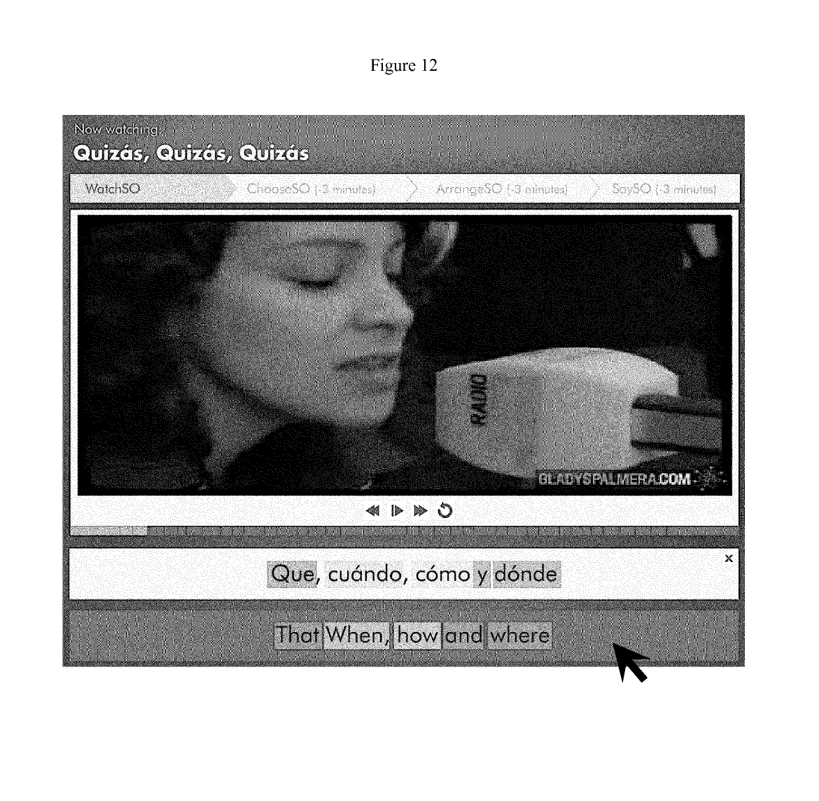

FIG. 12 shows an example of how the system can also highlight (e.g. show in a different color, size, or font) different words in the first language, and use corresponding highlighting to more clearly show the correspondence between words in the first language to be learned and the second language that the user is already familiar with.

Here, for example, in response to user input, when portions of the video (or audio) synchronized text are displayed in both the first language (that the user wants to learn) and the second language (that the user already is familiar with), the system can further differentially highlight those portions of the first language text that correspond to different parts of a sentence while similarly highlighting those portions of said the language that corresponds to the same parts of a text sentence.

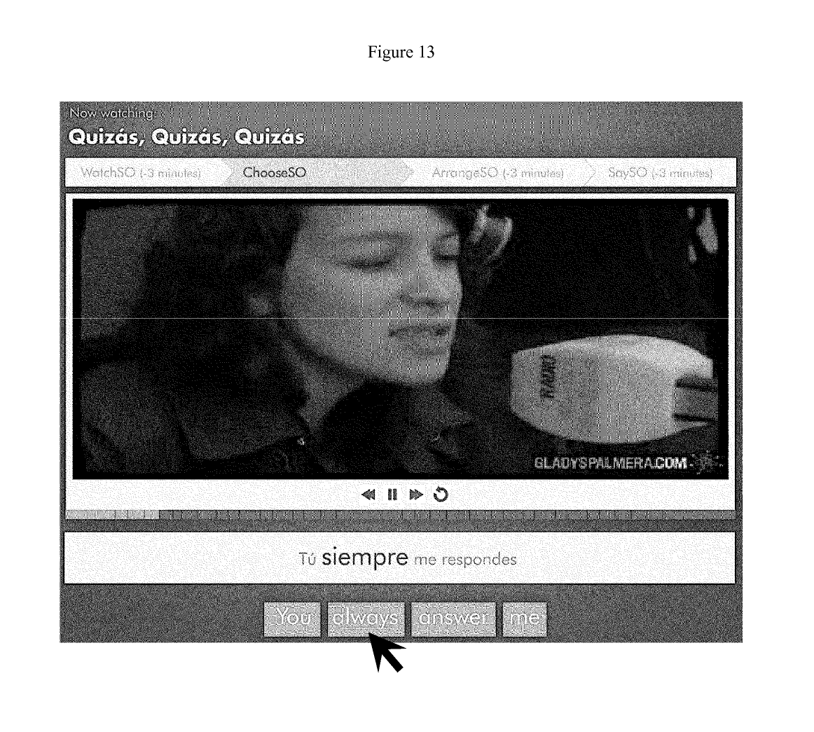

FIG. 13 shows an example of a user selecting a word in the second language that the user is already familiar with that corresponds to a highlighted word in the first language to be learned.

1. A computerized method of language instruction or practice, said method comprising:
obtaining video or audio media with spoken words in at least a first language that the user desires to learn or practice;
obtaining video or audio media synchronized text of said spoken words in both said first language and at least a second language that the user is familiar with;
producing instruction scripts that synchronize said synchronized text of said spoken words with said video or audio media, and which control which of said synchronized text of said spoken words are displayed on the graphical user interface of a user's computerized device in response to input from said user;
using script interpreter software configured to accept said video or audio media, said video or audio media synchronized text of said spoken words, and said instruction scripts, and based on said input from said user, play on said graphical user interface portions of said video or audio media, and portions of said video or audio media synchronized text;
wherein said video or audio media, said video or audio media synchronized text of said spoken words, and said instruction scripts utilize input from said user to convey language instruction.

2. The method of claim 1, further playing a portion of said video or audio media corresponding to a plurality of spoken words, and further showing on said graphical user interface said video or audio media synchronized text in said first language corresponding to said plurality of spoken words:
wherein said graphical user interface and said computerized device are configured to detect when said user's mouse, finger, or other pointing device is hovering over a portion of said video or audio media synchronized text in said first language corresponding to said plurality of spoken words;
wherein when said hovering over a specific word is detected, halting playback of said video or audio media, and displaying the corresponding text of said specific word in said second language.

3. The method of claim 2, wherein said script interpreter software and said instruction scripts record a list of which of said specific words are detected, and compare said specific words on said list with at least one list of the N most frequently used words in said first language, and use the overlap between said list of said specific words with said list of the N most frequently used words to estimate the vocabulary of said user in said first language.

4. The method of claim 1, wherein after playing either a portion of said video or audio media corresponding to a plurality of spoken words, and/or after displaying on said graphical user interface said video or audio media synchronized text in said first language corresponding to said plurality of spoken words, then:
further providing a user interface on said graphical user interface to allow said user to speak said plurality of words in said first language, and compare by either audio playback and/or visual sound comparison graphics on said graphical user interface, similarities and differences between said user spoken words and said plurality of spoken words from said video or audio media.

5. The method of claim 1, further, in response to user input, displaying portions of said video or audio media synchronized text in either said first language and/or said second language on said graphical user interface when said video or audio media are played on said script interpreter.

6. The method of claim 5, wherein in response to user input, when portions of said video or audio synchronized text are displayed in both said first language and said second language, further differentially highlighting those portions of said first language that correspond to different parts of a text sentence, while similarly highlighting those portions of said second language that correspond to the same parts of said text sentence.

7. The method of claim 1, further loading and storing on said computerized device:
said video or audio media synchronized text of said spoken words in both said first language and at least a second language,
said instruction scripts, and
said script interpreter software;
wherein when said user desires to use said method, said user obtains said video or audio media from a third party source, loads said video or audio media into the memory of said computerized device, and uses said third party source video or audio media for said method.

8. The method of claim 7, wherein said video or audio media with spoken words in a third language are subsequently dubbed with a dubbed synchronized audio file comprising spoken words in said first language;
further loading and storing on said computerized device:
said video or audio media synchronized text of said spoken words in both said first language and at least a second language,
said instruction scripts,
said script interpreter software;
and said dubbed synchronized audio file;
wherein when said user desires to use said method, said user's computerized device obtains said video or audio media from a third party source, and uses said third party source video or audio media and said dubbed synchronized audio file for said method.

9. The method of claim 1, further storing on a first language instruction internet server;
said video or audio media synchronized text of said spoken words in both said first language and at least a second language,
said instruction scripts and
said script interpreter software;
obtaining said video or audio media from a third party server;
wherein when said user desires to use said method, said user's computerized device downloads at least said video or audio media synchronized text of said spoken words in both said first language and at least a second language, and said instruction scripts from said first language instruction internet server;
and said computerized device further downloads said video or audio media from said third party server.

10. The method of claim 9, wherein said video or audio media comprise spoken words in either said second language that the user is familiar with, or a third language that the user does not wish to learn,
subsequently dubbing said video or audio media with a synchronized audio file comprising spoken words in said first language that said user wishes to learn, producing a dubbed synchronized audio file;
further storing said dubbed synchronized audio file on said first language instruction internet server;
wherein when said user desires to use said method, further downloading said dubbed synchronized audio file from said first language instruction internet server into said user's computerized device.

11. The method of claim 9, wherein said graphical user interface is controlled by script interpreter software running on a web browser running on said user's computerized device.

12. The method of claim 11, wherein said web browser further downloads at least some elements of said script interpreter software from said first internet server.

13. The method of claim 1, wherein said video or audio media synchronized text of said spoken words in both said first language and at least a second language provides both correct and incorrect versions of said synchronized text;
said instruction scripts direct said script interpreter software to display both correct and incorrect versions of said synchronized text, software, and further direct said user to select the correct version of said synchronized text;
wherein said script interpreter software and said instruction scripts detect said selections and inform said user as to the accuracy of said selections.

14. The method of claim 1, wherein, for at least some sections of said video or audio media with spoken words in at least said first language, after playing said sections on said script interpreter;
for each said section from at least some of said sections, said instruction scripts and said script interpreter break down said video or audio media synchronized text of said spoken words in either said first language and/or at least a second language into a plurality of subunits of said synchronized text of said spoken words in said section;
said script interpreter displays said subunits of said synchronized text of said spoken words in said section in a jumbled and non-correct order;
wherein if said user selects said subunits in an incorrect order, an error message is displayed on said graphical user interface; or
wherein if said language student selects said subunits in a correct order, a confirmation message is displayed on said graphical user interface.

15. The method of claim 1, wherein if said video or audio media only comprises spoken words in said a second language that the user is already familiar with or a third language that the user does not wish to learn, said video or audio media are subsequently dubbed with a synchronized audio file comprising spoken words in said first language that said user desires to learn or practice

16. The method of claim 1, further indexing said synchronized text of said spoken words at the sentence or phrase level, and displaying, on said graphical user interface, a selectable index allowing said user to access or replay at least some index selected sentences or phrases from said video or audio media.

17. A computerized method of language instruction or practice, said method comprising:
obtaining video or audio media with spoken words in at least a first language;
obtaining video or audio media synchronized text of said spoken words in both said first language and at least a second language;
producing instruction scripts that synchronize said synchronized text of said spoken words with said video or audio media, and which control which of said synchronized text of said spoken words are displayed on the graphical user interface of said user's computerized device in response to input from said user;
using script interpreter software configured to accept said video or audio media, said video or audio media synchronized text of said spoken words, and said instruction scripts, and based on said input from said user, play on said graphical user interface portions of said video or audio media, and portions of said video or audio media synchronized text;
wherein said video or audio media, said video or audio media synchronized text of said spoken words, and said instruction scripts work with input from said user to convey language instruction;
wherein said language instruction comprises further playing a portion of said video or audio media corresponding to a plurality of spoken words, and further showing on said graphical user interface said video or audio media synchronized text in said first language corresponding to said plurality of spoken words;
wherein said graphical user interface and said computerized device are configured to detect when said user's mouse, finger, or other pointing device is hovering over at least a portion of said video or audio media synchronized text in said first language corresponding to said plurality of spoken words;
wherein when said hovering at least a portion of said audio or video synchronized text is detected, displaying the corresponding text of said portion in said second language;
wherein after playing either a portion of said video or audio media corresponding to a plurality of spoken words, and/or after displaying on said on said graphical user interface said video or audio media synchronized text in said first language corresponding to said plurality of spoken words, then
further providing a user interface on said graphical user interface to allow said user to speak said plurality of words in said first language, and compare by either audio playback and/or visual sound comparison graphics on said graphical user interface, similarities and differences between said student's spoken words and said plurality of spoken words from said video or audio media.

18. The method of claim 17, further storing on a first language instruction internet server;
said video or audio media synchronized text of said spoken words in both said first language and at least a second language,
said instruction scripts and
said script interpreter software;
obtaining said video or audio media from a third party server;
wherein when said user desires to use said method, said user's computerized device downloads at least said video or audio media synchronized text of said spoken words in both said first language and at least a second language, and said instruction scripts, from said first language instruction internet server;
and further downloading said video or audio media from said third party server.

19. The method of claim 18, wherein said video or audio media comprises spoken words in a second or a third language;
Subsequently dubbing said video or audio media with a synchronized audio file comprising spoken words in said first language;
further storing said synchronized audio file on said first language instruction internet server;
wherein when said user desires to use said method, said user's computerized device downloads at least said video or audio media synchronized text of said spoken words in both said first language and at least a second language, said instruction scripts from said first language instruction internet server; and said synchronized audio file from said first language instruction internet server;
and further downloading said video or audio media from said third party server.

20. The method of claim 18, wherein said graphical user interface is produced by a web browser running on said user's computerized device; and
wherein said web browser further downloads at least some elements of said script interpreter software from said first language instruction internet server.

21. The method of claim 17, wherein said script interpreter software and said instruction scripts record a list of which of said specific words are detected, and compare said specific words on said list with at least one list of the N most frequently used words in said first language, and use the overlap between said list of said specific words with said list of the N most frequently used words to estimate the vocabulary of said user in said first language.
